(19) United States
(12) Patent Application Publication
(10) Pub. No.: US 2008/0296352 A1
(43) Pub. Date: Dec. 4, 2008

(54) BONDING METHOD FOR CYLINDRICAL TARGET

(76) Inventors: AKIHIRO HOSOKAWA, Cupertino, CA (US); Dieter Haas, Bruchkoebel (DE)

Correspondence Address: PATTERSON & SHERIDAN, LLP - - APPM/TX, 3040 POST OAK BOULEVARD, SUITE 1500, HOUSTON, TX, 77056, US

(21) Appl. No.: 11/755,579

(22) Filed: May 30, 2007

(51) Int. Cl. B23K 31/00; B23K 37/00

(52) U.S. Cl. 228/176; 228/57

(57) ABSTRACT

The present invention generally comprises a method and apparatus for bonding a cylindrical sputtering target to a backing tube. The cylindrical sputtering target may be disposed over the outside surface of the backing tube and melted bonding material may be vacuum pulled through the gap formed between the sputtering target and the backing tube. By vacuum pulling the melted bonding material through the gap, the amount of air bubbles or pockets present within the bonding material between the sputtering target and the backing tube may be reduced.

### BACKGROUND OF THE INVENTION

1. Field of the Invention

Embodiments of the present invention generally relate to a method and apparatus for bonding a cylindrical sputtering target to a backing tube.

2. Description of the Related Art

Physical vapor deposition (PVD), or sputtering as it is often called, is one method of depositing material onto a substrate. During a sputtering process, a target may be electrically biased so that ions generated in a process region may bombard the target surface with sufficient energy to dislodge atoms of target material from the target surface. The sputtered atoms may deposit onto a substrate that may be grounded to function as an anode. Alternatively, the sputtered atoms may react with a gas in the plasma, for example nitrogen or oxygen, to deposit onto the substrate in a process called reactive sputtering.

Direct current (DC) sputtering and alternating current (AC) sputtering are forms of sputtering in which the conductive target may be biased to attract ions towards the target. When the sputtering target is non-conductive, radio frequency (RF) sputtering may be used. The sides of the sputtering chamber may be covered with a shield to protect the chamber walls from deposition during sputtering and also to act as an anode in opposite to the biased target to capacitively couple the target power to the plasma generated in the sputtering chamber.

There are two general types of sputtering targets, planar sputtering targets and cylindrical sputtering targets. Both planar and cylindrical sputtering targets have their advantages. Cylindrical sputtering targets may be particularly beneficial in large area substrate processing. Therefore, there is a need in the art for methods and apparatus for producing cylindrical sputtering targets.

### SUMMARY OF THE INVENTION

The present invention generally comprises a method and apparatus for bonding a cylindrical sputtering target to a backing tube. The cylindrical sputtering target may be disposed over the outside surface of the backing tube and melted bonding material may be vacuum pulled through the gap formed between the sputtering target and the backing tube. By vacuum pulling the melted bonding material through the gap, the amount of air bubbles or pockets present within the bonding material between the sputtering target and the backing tube may be reduced.

In one embodiment, a method of bonding a cylindrical sputtering target to a backing tube is disclosed. The method comprises disposing a cylindrical sputtering target around a backing tube with a gap present between the sputtering target and the backing tube and vacuum pulling bonding material through the gap.

In another embodiment, a method of bonding a cylindrical sputtering target to a backing tube is disclosed. The method comprises injecting melted bonding material between the cylindrical sputtering target and the backing tube and vacuum drawing the injected, melted bonding material along a length of the cylindrical target while heating the cylindrical target and the backing tube.

In another embodiment, a sputtering target bonding apparatus for bonding a cylindrical sputtering target to a backing tube is disclosed. The apparatus comprises one or more first heating assemblies disposed adjacent a sputtering face of the cylindrical sputtering target, one or more second heating assemblies disposed adjacent an interior surface of the backing tube, a bonding material supply coupled with the cylindrical sputtering target and the backing tube, and a vacuum assembly coupled with the cylindrical sputtering target and the backing tube.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a cross sectional view of a cylindrical sputtering target assembly.

FIG. 1B is a top view of the cylindrical sputtering target assembly of FIG. 1A.

FIG. 1C is a schematic representation of a substrate in relation to cylindrical sputtering target assemblies.

FIG. 2 is a cross sectional view of an apparatus for bonding a cylindrical sputtering target to a backing tube according to one embodiment of the invention.

FIG. 3 is a cross sectional view of an apparatus for bonding a cylindrical sputtering target to a backing tube according to another embodiment of the invention.

FIG. 4 is a cross sectional view of an apparatus for bonding a cylindrical sputtering target to a backing tube according to another embodiment of the invention.

FIG. 5 is a cross sectional view of an apparatus for bonding a cylindrical sputtering target to a backing tube according to another embodiment of the invention.

FIG. 6A is a top view of a cylindrical sputtering target assembly.

FIG. 6B is a schematic view of the bonding layer of FIG. 6A unrolled.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present invention generally comprises a method and apparatus for bonding a cylindrical sputtering target to a backing tube. The cylindrical sputtering target may be disposed over the outside surface of the backing tube and melted bonding material may be vacuum pulled through the gap formed between the sputtering target and the backing tube. By vacuum pulling the melted bonding material through the gap, the amount of air bubbles or pockets present within the bonding material between the sputtering target and the backing tube may be reduced. The sputtering target assembly may be used in a PVD chamber, such as a PVD chamber available from AKT®, a subsidiary of Applied Materials, Inc., Santa Clara, Calif. or a PVD chamber available from Applied Materials Gmbh & Co. KG, located at Alzenau, Germany. However, it should be understood that the sputtering target assembly may have utility in other PVD chambers, including those chambers configured to process large area round substrates and those chambers produced by other manufacturers.

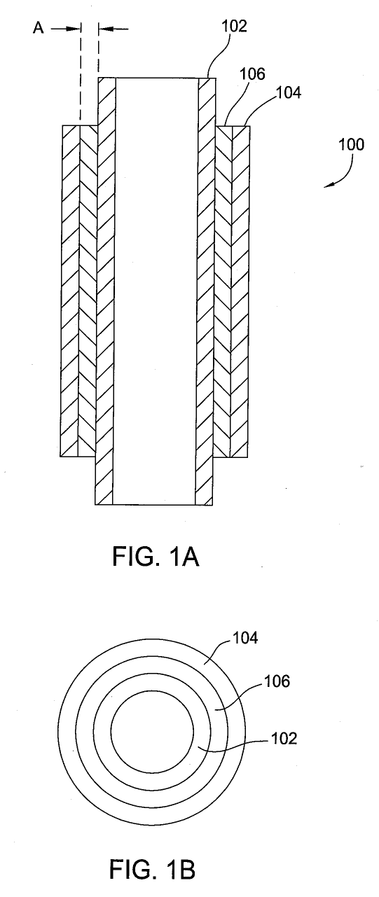

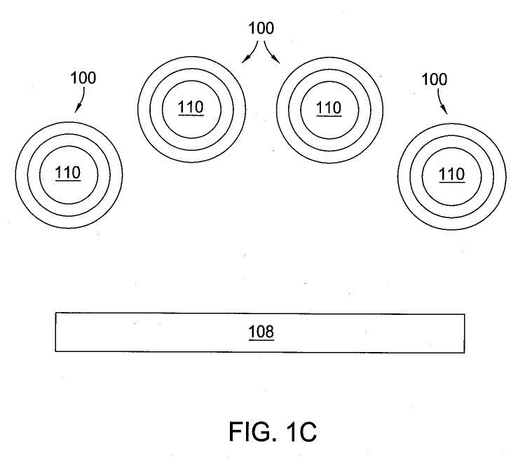

FIG. 1A is a cross sectional view of a cylindrical sputtering target assembly 100, and FIG. 1B is a top view of the cylindrical sputtering target assembly 100 of FIG. 1A. The sputtering target assembly 100 comprises a cylindrical sputtering target 104 bonded to cylindrical backing tube 102 by a bonding layer 106. The bonding layer 106 fills the gap between the backing tube 102 and the sputtering target 104. The gap has a width “A” as shown in FIG. 1A. In one embodiment, the gap may be between about 0.5 mm to about 1.0 mm thick. The cylindrical sputtering target 104 may comprise any well known sputtering material such as titanium, aluminum, copper, molybdenum, indium tin oxide (ITO) or combinations thereof. The backing tube 102 may comprise any well known backing tube material conventional in the art such as stainless steel, titanium, aluminum and combinations thereof. The bonding layer 106 may comprise any well known material for bonding sputtering targets to backing plates or tubes including indium based bonding material such as indium and indium alloys.

FIG. 1C is a schematic representation of a substrate 108 in relation to cylindrical sputtering target assemblies 100. One or more cylindrical sputtering target assemblies 100 may be disposed opposite a substrate in a processing chamber. The cylindrical sputtering target assemblies 100 may be disposed in a horizontal sputtering arrangement whereby the substrate 108 and the cylindrical sputtering target assemblies 100 are oriented substantially perpendicular to the ground. Alternatively, the sputtering target assemblies 100 and the substrate 108 may be oriented such that they are horizontal and thus, substantially parallel to the ground. Within the center 110 of the cylindrical sputtering target assemblies 100, one or more magnetrons may be present. The magnetrons may rotate within the center 110 of the cylindrical sputtering target assembly 100. Alternatively, one or more magnetrons may be disposed outside the cylindrical sputtering target assemblies 100 opposite the substrate 108. Additionally, cooling mechanisms, such as cooling fluid tubes, may be disposed within the center 110 of the cylindrical target assemblies 100. The cylindrical sputtering target assemblies 100 may be rotatable about the center axis of the assembly 100 to promote uniform target erosion.

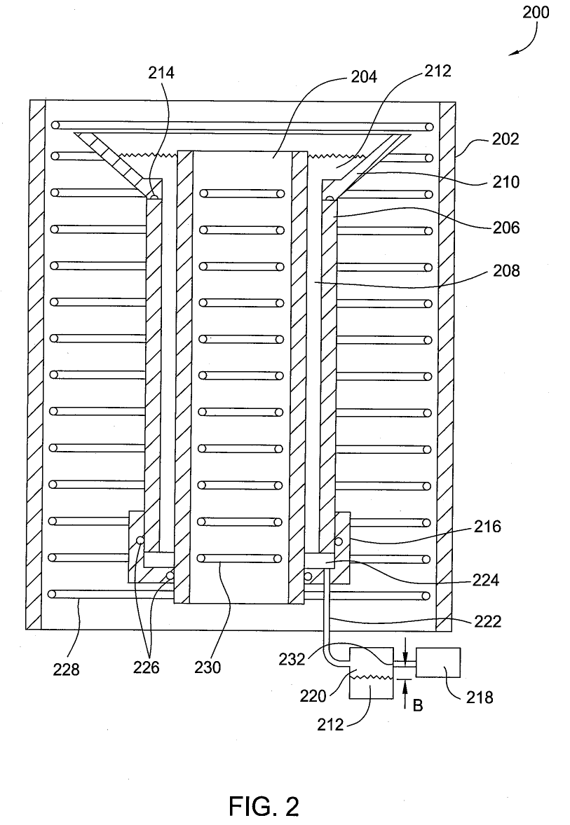

FIG. 2 is a cross sectional view of an apparatus 200 for bonding a cylindrical sputtering target 206 to a backing tube 204 according to one embodiment of the invention. The apparatus 200 may comprise an enclosure 202 within which the sputtering target 206 may be bonded to the backing tube 204. The sputtering target 206 may initially be disposed over the outside of the backing tube 204 so that a gap 208 remains between the sputtering target 206 and the backing tube 204.

A funnel 210 or other structure capable of holding bonding material 212 may be coupled to the top of the sputtering target 206. An O-ring 214 may be present at the coupling between the funnel 210 and the sputtering target 206 to reduce the possibility of melted bonding material 212 from seeping out between the funnel 210 and the sputtering target 206. The funnel 210 may be sized and shaped to permit melted bonding material 212 to flow downward into the gap 208 present between the sputtering target 206 and the backing tube 204.

A cap portion 216 may be coupled with the bottom end of the sputtering target 206 and backing tube 204 to capture any excess bonding material 212 that flows through the gap 208. The excess bonding material 212 may collect within an area 224 of the cap portion 216. A vacuum pump 218 may be coupled with the cap portion 216 to draw a vacuum in the area 224 of the cap portion 216 and the gap 208 to vacuum pull the melted bonding material 212 through the gap. The vacuum may work in cooperation with the force of gravity to pull the bonding material 212 through the gap 208. O-rings 226 may seal the cap portion 216 to both the sputtering target 206 and the backing tube 204 to aid in drawing a vacuum in the cap portion 216.

The excess bonding material 212 is pulled by the vacuum 218 out of the cap portion 216 through a line 222 that is coupled with a tank 220. The excess bonding material may drop into the bottom of the tank 220 while the vacuum is drawn through the top of the tank. The vacuum tank inlet may be disposed a distance “B” above the maximum expected height of excess bonding material 212 in the tank 220. A filter 232 may be disposed on the vacuum tank inlet that is capable of permitting gas to diffuse therethrough without permitting solid or liquid to pass therethrough. The cap portion 216 works as a centering device to maintain the gap between the tube 204 and the target 206 substantially uniform.

Heating elements 228 may be disposed along the outside of the funnel 210, cap portion 216, and sputtering target 206. The heating elements 228 may span at least the length of the sputtering target 206. Additional heating elements 230 may be disposed inside the backing tube 204. In one embodiment, the funnel 210 may comprise its own independent heating element. The heating elements 228, 230 may maintain the bonding material 212 above its melting point so that the bonding material may flow and be vacuum pulled through the gap 208. The heating elements 228, 230 may comprise heating coils, heating fluid, or combinations thereof.

To bond the sputtering target 206 to the backing tube 204, the area of the gap 208 may be calculated to determine the volume of bonding material 212 that will be needed to fill the gap 208. A sufficient amount of bonding material 212 to fill the gap 208 may be disposed in the funnel 210. If desired, additional bonding material 212 beyond the amount necessary to fill the gap 208 may be disposed in the funnel 210. In one embodiment, about 100 percent to about 300 percent additional bonding material 212 may be present. The heating elements 228, 230 may maintain the bonding material 212 above its melting temperature. In one embodiment, the heating elements may maintain the boding material 212 at a temperature greater than about 200 degrees Celsius. The heating elements 228, 230 may be coupled to a controller (not shown) as may be the vacuum pump 218.

The vacuum pump 218 may draw a vacuum and pull the bonding material 212 through the gap in the direction of the flow of gravity. In one embodiment, the vacuum pump 218 may draw a vacuum pressure of about 1 mbar to about 10 mbar. If excess bonding material is used, it may collect in the area 224 of the cap portion 216 and the tank 220. Once all of the bonding material is out of the funnel 210, then the heating elements 228, 230 may be turned off to permit the bonding material 212 to rise above its melting point and solidify within the gap 208.

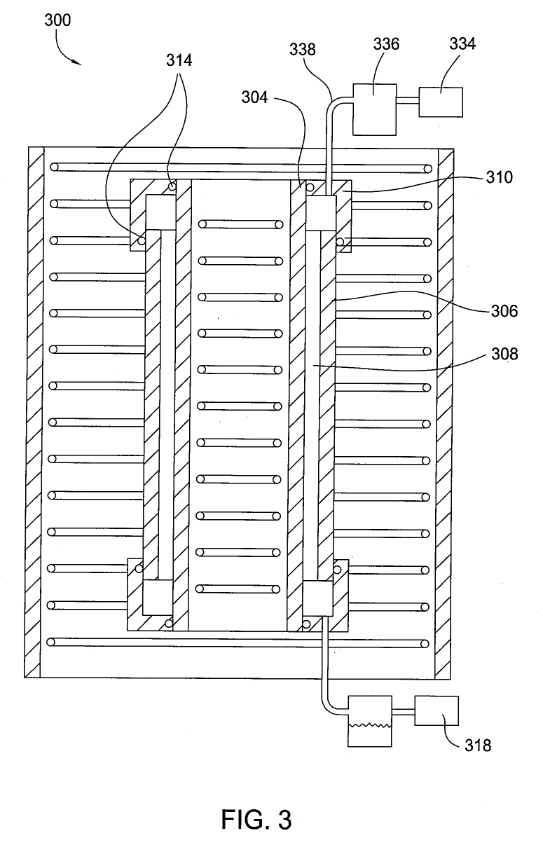

FIG. 3 is a cross sectional view of an apparatus 300 for bonding a cylindrical sputtering target 306 to a backing tube 304 according to another embodiment of the invention. Rather than a funnel 210 as shown in FIG. 2, an end cap 310 may be vacuum sealed to the sputtering target 306 and the backing tube 314 by O-rings 314 to reduce the possibility of melted bonding material leaking. The bonding material may be fed to the end cap 310 under pressure by a pump 334 from a source 336 through a line 338. The end cap 310 works as a centering device to maintain the gap between the tube 304 and the target 306 substantially uniform. The bonding material may be melted at the source 336 and fed through the line 338 under a pressure of about 60 psi to about 70 psi. In one embodiment, the pump 334 may be a plunger-type pump. A vacuum pump 318 may still draw the bonding material through the gap 308 in addition to the pump 334 that injects the bonding material to the end cap 310. Thus, in the embodiment depicted in FIG. 3, the vacuum pump 318, the pump 334, and the effects of gravity collectively aid in forcing and/or drawing the bonding material through the gap 308 between the sputtering target 306 and the backing tube 304.

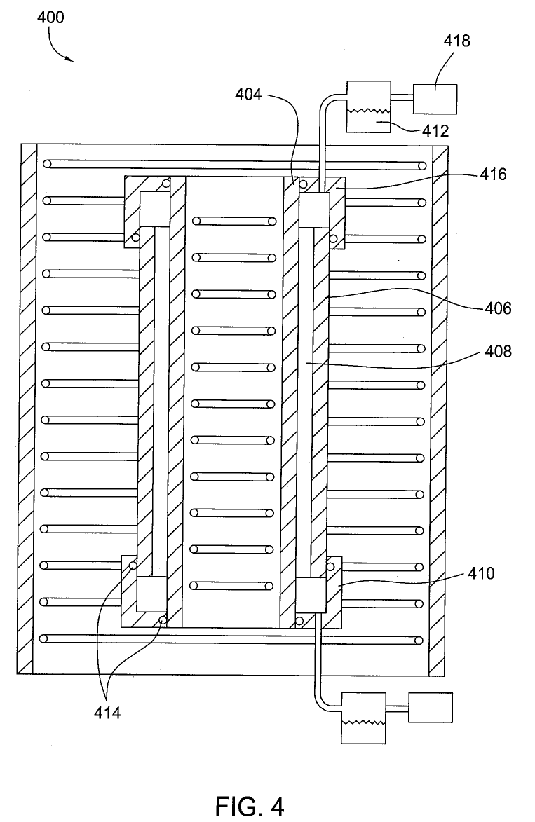

FIG. 4 is a cross sectional view of an apparatus 400 for bonding a cylindrical sputtering target 406 to a backing tube 404 according to another embodiment of the invention. Rather than having the vacuum pump 418 working with the force of gravity, the vacuum pump 418 pulls the bonding material 412 up through the gap 408 against the force of gravity. A predetermined amount of bonding material 412 may be disposed in the end cap 410 coupled to the sputtering target 406 and the backing tube 404 with O-rings 414. The bonding material 412 may be vacuum pulled up the gap 408 from the end cap 410 to the cap portion 416 by the vacuum pump 418.

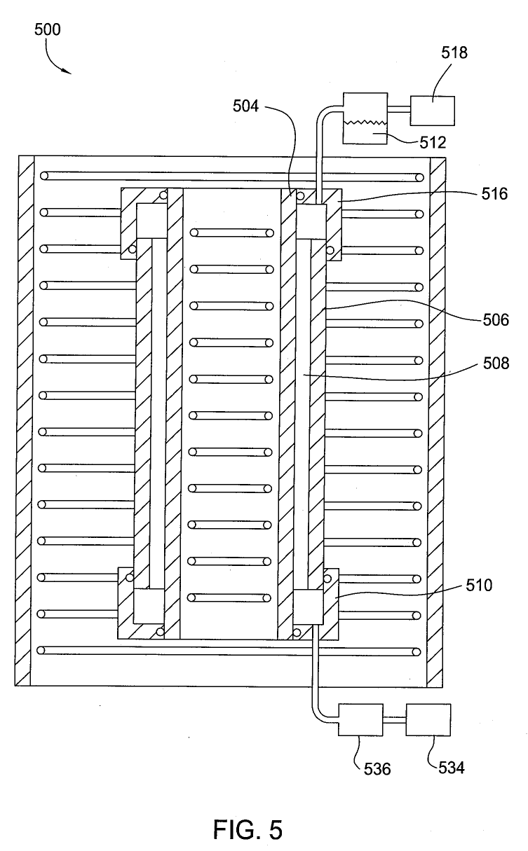

FIG. 5 is a cross sectional view of an apparatus 500 for bonding a cylindrical sputtering target 506 to a backing tube 504 according to another embodiment of the invention. Similar to the embodiment discussed above in relation to FIG. 4, the vacuum pump 518 pulls the bonding material 512 through the gap 508 and into the cap portion 516 against the flow of gravity. However, in addition to pulling the bonding material 512 by vacuum, the bonding material 512 may be delivered to an end cap 510 from a source 536 by a pump 534. Thus, the bonding material 512 may be supplied to an end cap 510 under pressure and be pulled through the gap 508 by vacuum.

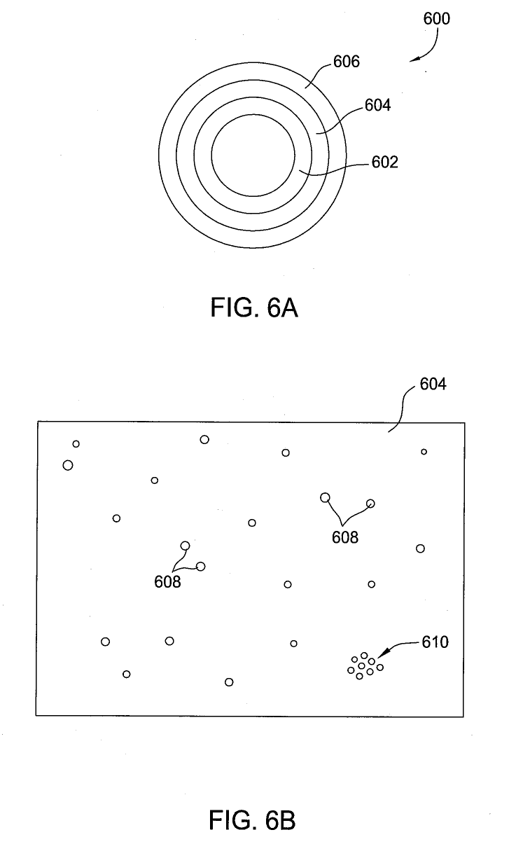

The industry standard for bonding a cylindrical sputtering target to a backing tube is to achieve greater than 90 percent filling of the gap between the target and backing tube. In other words, 10 percent or less bubbles present in the bonding layer meets the industry standard. FIG. 6A is a top view of a cylindrical sputtering target assembly 600 having a sputtering target 606 bonded to a backing tube 602 by a bonding layer 604. Once the sputtering target assembly 600 is assembled, the amount of bubbles present in the bonding layer 604 may be determined by X-ray. FIG. 6B is a schematic view of the bonding layer of FIG. 6A unrolled. The bubbles 608 may be spaced across the bonding layer 604 such that the total amount of bubbles present in the bonding layer is 10 percent or less. If the bonding layer 604 comprises more than 10 percent bubbles, then the bonding material may be re-melted and removed so that the sputtering target 606 may be re-bonded to the backing tube 602. In some cases, the percentage of bubbles 608 within the bonding layer 604 may be less than 10 percent, but a cluster 610 of bubbles may be concentrated in one area. The cluster of bubbles may create a problem when the sputtering target assembly 600 is used because the bubbles comprise air and could lead to overheating of the sputtering target 604. When the sputtering target 604 overheats, the sputtering target 604 may crack and contaminate a sputtering process.

By using a vacuum to pull the bonding material through a gap present between the sputtering target and the backing tube, the percentage of bubbles present in the bonding layer may be less than 10 percent or less, preferably 5 percent or less and the amount of clusters may be reduced. Specifically, using a vacuum to pull the bonding material through the gap may permit consistent, repeatable bonding of sputtering targets to backing tubes with few, if any, bubbles.

While the foregoing is directed to embodiments of the present invention, other and further embodiments of the invention may be devised without departing from the basic scope thereof, and the scope thereof is determined by the claims that follow.

1. A method of bonding a cylindrical sputtering target to a backing tube, comprising:
disposing a cylindrical sputtering target around a backing tube with a gap present between the sputtering target and the backing tube; and
vacuum pulling bonding material through the gap.

2. The method of claim 1, wherein the cylindrical sputtering target comprises molybdenum, indium tin oxide, titanium, aluminum or combinations thereof.

3. The method of claim 1, wherein the backing tube comprises titanium, aluminum or combinations thereof.

4. The method of claim 1, wherein the bonding material comprises indium or an indium alloy.

5. The method of claim 1, further comprising heating the bonding material.

6. The method of claim 1, wherein the cylindrical sputtering target and the backing tube are oriented such that the bonding material is additionally pulled by the force of gravity.

7. The method of claim 1, wherein the cylindrical sputtering target and the backing tube are oriented such that the bonding material is pulled against the force of gravity.

8. A method of bonding a cylindrical sputtering target to a backing tube, comprising:
injecting melted bonding material between the cylindrical sputtering target and the backing tube; and
vacuum drawing the injected, melted bonding material along a length of the cylindrical target while heating the cylindrical target and the backing tube.

9. The method of claim 8, wherein the cylindrical sputtering target comprises molybdenum, indium tin oxide, titanium, aluminum or combinations thereof.

10. The method of claim 8, wherein the backing tube comprises titanium, aluminum or combinations thereof.

11. The method of claim 8, wherein the bonding material comprises indium or an indium alloy.

12. The method of claim 8, wherein the cylindrical sputtering target and the backing tube are oriented such that the bonding material is additionally pulled by the force of gravity.

13. The method of claim 8, wherein the cylindrical sputtering target and the backing tube are oriented such that the bonding material is pulled against the force of gravity.

14. A sputtering target bonding apparatus for bonding a cylindrical sputtering target to a backing tube, comprising:
one or more first heating assemblies disposed adjacent a sputtering face of the cylindrical sputtering target;
one or more second heating assemblies disposed adjacent an interior surface of the backing tube;
a bonding material supply coupled with the cylindrical sputtering target and the backing tube; and
a vacuum assembly coupled with the cylindrical sputtering target and the backing tube.

15. The apparatus of claim 14, wherein the bonding material supply comprises a funnel assembly.

16. The apparatus of claim 14, wherein the bonding material supply comprises a cap portion enclosing and centering a gap between the cylindrical sputtering target and the backing tube.

17. The apparatus of claim 16, wherein the bonding material supply further comprises a pump coupled with the cap portion.

18. The apparatus of claim 14, wherein the vacuum assembly further comprises:
an end cap coupled with the cylindrical sputtering target and the backing tube to enclose and center a gap between the cylindrical sputtering target and the backing tube; and
a vacuum pump coupled with the end cap.

19. The apparatus of claim 14, wherein the bonding material supply is disposed at a location above the vacuum assembly relative to ground.

20. The apparatus of claim 14, wherein the bonding material supply is disposed at a location below the vacuum assembly relative to ground.
